(19) United States
(12) Patent Application Publication
(10) Pub. No.: US 2006/0260388 A1
(43) Pub. Date: Nov. 23, 2006

(54) PROBE AND METHOD FOR A SCANNING PROBE MICROSCOPE

(76) Inventors: Chanmin Su, Ventura, CA (US); Jian Shi, Goleta, CA (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/380,349

(22) Filed: Apr. 26, 2006

Related U.S. Application Data
(60) Provisional application No. 60/674,967, filed on Apr. 26, 2005.

(51) Int. Cl. G01B 5/28

(52) U.S. Cl. 73/105

(57) ABSTRACT

A measurement instrument probe has an outwardly extending sensing lever having at least two sections, one section that, at least during operation, has a different effective spring constant than an effective spring constant of another section of the lever. The sensing lever preferably includes a cantilever that is fixed at or adjacent one end of the cantilever, and includes a probing lever stage is preferably disposed at or adjacent to a free end of the cantilever and the cantilever can be driven or excited in a manner that causes the probing lever stage to have an effective spring constant, k₁, that is greater than an effective spring constant, k₂, of at least one other lever stage disposed between the probing lever stage and where the cantilever is fixed. Alternatively, the sensing lever is fabricated to include a probing lever stage that is more stiff than at least one other lever stage substantially contiguous therewith.

### CROSS REFERENCE TO RELATED APPLICATION

This application claims priority under 35 U.S.C. Section 119(e) to U.S. Provisional Application Ser. No. 60/674,967, filed Apr. 26, 2005, the entirety of which is hereby expressly incorporated herein by reference.

### FIELD OF THE INVENTION

The present invention is directed to a probe for a metrology instrument, and more particularly to a an AFM probe having a sensing or measurement lever that has at least two regions, one of which has a substantially lower spring constant than another of the regions during operation.

### BACKGROUND

While probe based instruments have enjoyed great success and application over a wide range of uses, operating conditions and the like, improvements thereto nonetheless remain desirable. For example, there are instances where the probe can become damaged or fail prematurely during operation, which obviously is undesirable.

In one particular instance, depending upon the mode and application, the force required to pull the probe free from a sample being analyzed can become so great that the probe will permanently plastically deform or even break. In at least the latter case, the probe is unusable and must be replaced before operation can continue.

One such probe based instrument used to perform a wide range of nano and atomic scale analyses measurement applications is an atomic force microscope (AFM). This type of probe based measurement instrument employs a measurement probe equipped with a sensing element that preferably is a stylus-type tip or the like. A preferred measurement probe is a cantilever having at least one lever that outwardly projects from a base that can be a substrate, such as a chip-type substrate or the like. Such a cantilever preferably includes at least one lever having an unsupported free end, at least a portion of which is typically used in analyzing a sample. These types of cantilever's typically are equipped with at least one tip which interacts with the sample being analyzed.

A typical AFM system is shown schematically in FIG. 1. An AFM 10 employing a probe device 12 including a probe 14 having a cantilever 15 is coupled to an oscillating actuator or drive 16 that is used to drive probe 14, in this case, at or near the probe's resonant frequency. Commonly, an electronic signal is applied from an AC signal source 18 under control of an AFM controller 20 to cause actuator 16 to drive the probe 14 to oscillate, preferably at a free oscillation amplitude A₀. Probe 14 is typically actuated toward and away from sample 22 using a suitable actuator or scanner 24 controlled via feedback by controller 20. Notably, the actuator 16 may be coupled to the scanner 24 and probe 14 but may be formed integrally with the cantilever 15 of probe 14 as part of a self-actuated cantilever/probe. Moreover, though the actuator 24 is shown coupled to the probe 14, the actuator 24 may be employed to move sample 22 in three orthogonal directions as an XYZ actuator.

For use and operation, one or more probes may be loaded into the AFM and the AFM may be equipped to select one of several loaded probes. Typically, the selected probe 14 is oscillated and brought into contact with sample 22 as sample characteristics are monitored by detecting changes in one or more characteristics of the oscillation of probe 14, as described above. In this regard, a deflection detection apparatus 17 is typically employed to direct a beam towards the backside of probe 14, the beam then being reflected towards a detector 26, such as a four quadrant photodetector. As the beam translates across detector 26, appropriate signals are transmitted to controller 20, which processes the signals to determine changes in the oscillation of probe 14. Commonly, controller 20 generates control signals to maintain a constant force between the tip and sample, typically to maintain a setpoint characteristic of the oscillation of probe 14. For example, controller 20 is often used to maintain the oscillation amplitude at a setpoint value, As, to insure a generally constant force between the tip and sample. Alternatively, a setpoint phase or frequency may be used.

AFMs may be designed to operate in a variety of modes, including contact mode and oscillating mode. In contact mode operation, the microscope typically scans the tip across the surface of the sample while keeping the force of the tip on the surface of the sample generally constant. In the contact mode, the tip is subjected to a substantially constant force pressing the sample. Notably, the amount of force is measured by cantilever deflection. A feedback loop is used to maintain constant deflection while the tip scans across the sample surface. Topographic mapping is accomplished by moving either the sample or the probe assembly vertically to the surface of the sample in response to sensed deflection of the cantilever as the probe is scanned horizontally across the surface. In this way, the data associated with this vertical motion can be stored and then used to construct an image of the sample surface corresponding to the sample characteristic being measured, e.g., surface topography. One main disadvantage of Contact Mode operation is that the friction forces produced when the tip moves laterally contribute greatly to tip wear, especially on hard samples, and sample damage, for example, due to scratching, especially if the sample is soft and deformable. Alternatively, some AFMs can at least selectively operate in an oscillation mode of operation such as TappingMode™. (TappingMode™ is a trademark of Veeco Instruments, Inc.) In TappingMode operation, the tip is oscillated at or near a resonant frequency of the cantilever of the probe. The amplitude or phase of this oscillation is kept constant during scanning using feedback signals, which are generated in response to tip-sample interaction. As in contact mode, these feedback signals are then collected, stored, and used as data to characterize the sample.

A key benefit of operating in TappingMode is that the corresponding intermittent contact minimizes shear forces that can operate to compromise the integrity of the tip and/or sample. Also, the corresponding lever is sufficiently stiff to maintain an intermittent contact relationship between the tip and sample, i.e., overcome adhesion forces and capillary forces, etc. Tapping at or near the resonance frequency of the probe reduces the interaction force by a factor of Q (quality factor of the probe) for the same amount of tip displacement or cantilever deflection, as shown in the equation:

$$< f {>}_{tapping} ∝ \frac{k \cdot {z}_{tip}}{Q} = \frac{1}{Q} \cdot < f {>}_{contact} \qquad ( 1 )$$

where k is the spring constant and zₜᵢₚ is the deflection of the tip.

Furthermore, operating the probe at an acoustic frequency also reduces susceptibility of the AFM system to mechanical vibration and environmental instability, such as temperature induced drift in deflection. As a result, TappingMode has gained popularity and has become the dominant imaging mode in AFM applications. Notably, the Q factor in an ambient environment is typically a few hundred, implying a reduction of the interaction force, or increase in sensitivity to interaction forces by more than two orders of the magnitude.

However, these benefits of TappingMode imaging come with a price. First note that the transfer function of the TappingMode probe is a second order function with the bandwidth determined by the time constant of:

$$\frac{1}{τ} = \frac{ϖ}{2 Q} \qquad ( 2 )$$

with Q of 300, frequency f=ω/2π=about 200 kHz, the bandwidth of the tapping is only about 2 kHz, allowing imaging speed of about 1 line per second. In contrast, a contact probe of the same frequency and Q has a bandwidth of about 100 kHz when imaging in Contact Mode. Therefore, a key benefit to operating in contact mode is that contact response dynamics are far superior to those of TappingMode (given that the “Q” of the cantilever is not involved to limit performance). As a result, much faster response times (and thus operation) is possible in contact mode.

Effort was made to increase tapping bandwidth by reducing cantilever spring constant k and increasing resonance frequency f. Given the ambient Q as a constant, a smaller or equivalent k but much higher f will increase cantilever bandwidth. The only possible way to make cantilevers satisfy these constraints is to make cantilevers a much smaller size. The decrease of k also has a physical limit in that the energy of the tapping in each cycle should be sufficient to overcome the capillary force so that the cantilever probe is not trapped by the water meniscus when the tip lands on the sample surface. In general, during imaging, the bandwidth and stability of the feedback loop demands that the cantilever be stiffer when tapping while keeping interaction forces due to interaction at the tip smaller, preferably with complete removal of friction forces.

Regardless of their mode of operation, AFMs can obtain resolution down to the atomic level on a wide variety of insulating or conductive surfaces in air, liquid or vacuum by using piezoelectric scanners, optical lever deflection detectors, and very small cantilevers fabricated using photolithographic techniques. Because of their resolution and versatility, AFMs are important measurement devices in many diverse fields ranging from semiconductor manufacturing to biological research. Referring more particularly to the issues referenced above as they pertain to AFM operation, including during tip-sample engage, a part of the cantilever lever, typically that part which includes the probe tip, is brought into close proximity to the sample being analyzed. When it gets close enough, intermolecular forces, including Van der Waals forces, influence interaction between the probe tip and sample. For example, referring to FIG. 2, weak Van der Waals forces initially weakly attract the tip to the sample before the tip moves close enough to the sample such that stronger electrostatic repulsive forces become more dominant. Thereafter, additional tip movement toward the sample causes it to reach a region where attractive adhesion forces become dominant until the tip is nearly in actual physical contact or in actual physical contact with the sample (e.g., snap to contact), thereafter resulting in a repulsive force that actually is the force of the sample pushing against the probe.

When the cantilever is moving away from the sample (for example, when performing a force curve measurement or in Tapping Mode operation), these same forces are encountered in converse. As a result, as shown in FIG. 2, the force-displacement curve 30 representing cantilever and tip movement toward the sample is very similar to the force-displacement curve 32 representing cantilever and tip movement away from the sample.

While the large attractive force that an approaching cantilever experiences as the tip gets very close to the sample generally does not cause tip failure, this same attractive force can be problematic when the tip is moving away from the sample. In addition, while FIG. 2 generally represents a somewhat ideal force-displacement curve, other events can enter the picture that can greatly increase the attractive force beyond that which is depicted in FIG. 2 to the point where cantilever movement of the tip away from the sample causes the tip to break, pulls the tip off of the cantilever, or causes the cantilever to break.

For example, where the tip comes in contact with liquid or some other foreign matter different than the sample, the close proximity attractive force can greatly increase beyond that which the cantilever can accommodate without failing in a manner the same as or like that previously mentioned. More specifically, where the tip unexpectedly comes into contact with liquid, such as what can occur in a hydrophilic sample, close proximity attractive force can significantly increase and spike due to the addition of capillary forces that cause the tip to essentially “stick.”

When the cantilever and its tip are displaced back and forth relative to the sample, such as when an AFM is being operated in an oscillatory mode of operation like TappingMode, the force-displacement curve is repeated each time the cantilever and tip are moved toward and into close proximity to the sample and then away from the sample, such as typically occurs in a single oscillatory cycle. One such oscillatory mode of operation referred to earlier, TappingMode operation, the tip of the cantilever is tapped against the sample being analyzed when scanning the sample.

Any time this close proximity attractive force becomes greater than what the cantilever can accommodate, even when operating in TappingMode™, cantilever failure can occur. In particular, any time “sticking” occurs, the likelihood of cantilever failure is dramatically increased, particularly where the cantilever is relatively stiff or less compliant.

FIG. 2A displays a typical situation when sticking occurs. In general, the amplitude (e.g., the peak-to-peak amplitude in TappingMode) gets smaller in the “approach” branch “P” as tip-sample separation is reduced. In the approach branch, the tip is moved so that it continues to be at an average position closer to the surface and then commonly experiences a capillary force that will trap the tip. As a result, upon withdraw (branch “Q”), it takes a distance δZ for the amplitude to recover again. This hysteresis loop pertaining to amplitude will cause possible dual z position readings at the same amplitude, as shown at A₁ and A₂ for example. Since tapping control is based on amplitude, such dual values will cause instability in the feedback control loop, such that a jump from A₁ to A₂ unpredictably can cause a δZ to be as large as hundreds of nanometers, especially for a very compliant cantilever (e.g., a contact mode lever). Given typical TappingMode amplitudes of only 30 to 60 nm, such a situation will cause complete failure of the feedback loop. This is the primary reason that the contact cantilever, while having a much lower cantilever spring constant, typically from 0.05 to 0.6 N/m, cannot be used in perform TappingMode.

What is needed is a probe and method capable of accommodating large increases in close proximity attractive forces, including unexpectedly large close proximity attractive forces as what can occur during “sticking,” without the cantilever failing, ideally while improving response performance. Furthermore, a device that includes the advantages of both methods, i.e., removing shear force in TappingMode and high response bandwidth in Contact Mode, is highly desired in order to increase AFM control speed.

### SUMMARY

The preferred embodiments are directed to a probe and method of operating the same that is able to accommodate close proximity attractive forces, including unexpectedly large attractive forces, such as which occur during “sticking” between the probe tip and sample, yet achieve the dynamic bandwidth of contact mode operation. More particularly, according to the preferred embodiments, a probe that includes a cantilever has a plurality of sections, at least one of which has a different effective spring constant than another of its contiguous sections during operation. In one embodiment, a more stiff section of the cantilever of the probe is disposed at the distal portion of the probe which carries the probe tip, such that forces acting on the tip are coupled to the more compliant section of the cantilever which is fixed. In this way, sensitivity is maintained and can even be improved while maintaining the integrity of the probe. In an alternative more preferred embodiment, the probe is driven or excited in a manner that causes at least one of a plurality of sections of the cantilever to operate with a lower effective spring rate and lower effective modulus than another of the lever sections. In this case, a conventional cantilever having a constant width and/or thickness and made of the same material along its entire length can be used.

According to one aspect of the preferred embodiment, a measurement instrument probe has an outwardly extending sensing lever having a plurality of sections, including one section that has a different spring constant than another one of the sections during operation.

In another aspect of this embodiment, the sensing lever includes a cantilever that is fixed at or adjacent one end of the cantilever. Preferably, a probing lever stage or region that is stiffer, at least during operation, than at least one other lever stage or region is provided.

In yet another aspect of this embodiment, the probing lever stage is disposed at or adjacent to a free end of the cantilever, has a spring constant greater than a spring constant of a less stiff lever stage that is disposed between the probing lever stage and where the cantilever is fixed.

According to another aspect of this embodiment, the less stiff lever stage has a width, W₂, sufficiently wide such that an incident beam from a beam generator of a force and/or deflection detection arrangement has a width or diameter such that the beam can impinge against the less stiff lever stage with the entire portion of the beam spot where it impinges being located on an exterior surface of the less stiff lever stage. In a still further aspect of this preferred embodiment, the probe is driven so as to oscillate the probing lever stage. Moreover, the cantilever preferably oscillates at a resonant frequency and interacts with the sample by tapping on the sample.

According to another aspect of this preferred embodiment, the probing lever stage is disposed at or adjacent to a free end of the cantilever and the cantilever is driven or excited in a manner that causes the probing lever stage to have an effective spring constant, k₁, that is greater than an effective spring constant, k₂, of at least one other lever stage disposed between the probing lever stage and where the cantilever is fixed.

The control feedback is based on Contact Mode operation using the displacement of the weaker spring, k₂ or k_{soft}, while k₁ is driven to oscillate at a sufficient amplitude that can overcome capillary or sticking forces. In this manner, the feedback takes advantage of Contact Mode dynamics, while maintaining actual tip/surface interaction in TappingMode, thus minimizing Contact Mode friction forces that wear the tip or the sample.

In a still further aspect of this embodiment, the probing lever stage and the at least one other lever stage have substantially the same spring constant when the cantilever is not being driven in a manner that causes their effective spring constants to differ.

According to another aspect of this embodiment, the effectively less stiff one other lever stage has a longitudinal length, L₂, that is at least a plurality of times longer than a longitudinal length, L₁, of the effectively stiffer probing lever stage.

In another aspect of the preferred embodiment, a cantilever for an AFM probe includes a probing lever stage carrying a sensing element at or adjacent to a free end of the cantilever that is less compliant than another lever stage disposed interjacent the probing lever stage and where the cantilever is fixed.

In yet another aspect of the preferred embodiment, a scanning probe microscope includes a probe having a cantilever supporting a tip that interacts with a sample. In addition, the scanning probe microscope includes a drive to drive the probe, wherein the probe and the drive are configured to disperse forces exerted by the sample on the tip.

In another aspect of the preferred embodiment, a method of operating a surface analysis instrument having a probe includes a cantilever having a plurality of regions. The method includes using at least a first one of the regions to interact with a sample, the interaction being coupled to at least a second one of the regions of the probe. The method also includes sensing a response of the second one of the regions and controlling a positioning stage in response to the sensing step.

In another aspect of this preferred embodiment, the regions of the probe include an outwardly extending sensing lever section that, at least during operation, has a spring constant that is different than a spring constant of another section adjacent to the one section.

These and other objects, features and advantages of the invention will become apparent to those skilled in the art from the following detailed description and the accompanying drawings. It should be understood, however that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred exemplary embodiment of the invention is illustrated in the accompanying drawings in which like reference numerals represent like parts throughout, and in which:

FIG. 1 is a schematic illustration of a SPM, appropriately labeled “PRIOR ART”;

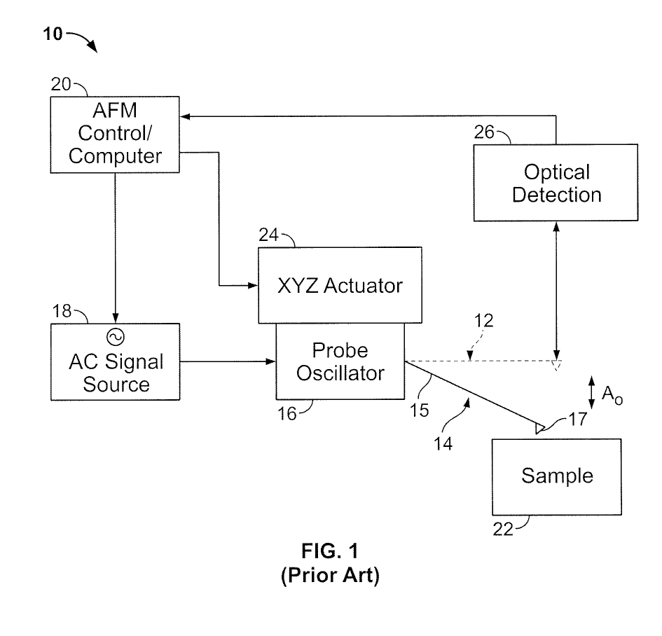

FIG. 2 illustrates a force-displacement curve and amplitude-displacement curve of a cantilever operating in TappingMode™;

FIG. 2A depicts a graph illustrating sticking between the probe and sample;

FIG. 3 depicts a top plan view of one exemplary embodiment of a multistage cantilever constructed in accordance with the present invention;

FIG. 4 illustrates the probe of FIG. 2 equipped with a direct-contact mechanical cantilever drive arrangement;

FIG. 5 depicts spring-mass diagram for the probe of FIG. 2;

FIG. 6 illustrates another exemplary embodiment of a probe constructed in accordance with the invention used in an AFM;

FIG. 6A illustrates an exemplary embodiment of a probe constructed in accordance with the invention used in an AFM;

FIG. 7 is a preferred embodiment of a multistage cantilever that is driven into multistage operation via exciting or driving the cantilever to induce harmonics in a lever section adjacent a probing lever section at or adjacent the free end;

FIG. 8 is another preferred embodiment of a multistage cantilever constructed and operated in accordance with the present invention; and

FIG. 9 is another preferred embodiment of a multistage probe including at least two cantilevers with substantially different spring constants or probe properties that are constructed in parallel and operated in accordance with the present invention.

### DETAILED DESCRIPTION OF AT LEAST ONE PREFERRED EMBODIMENT

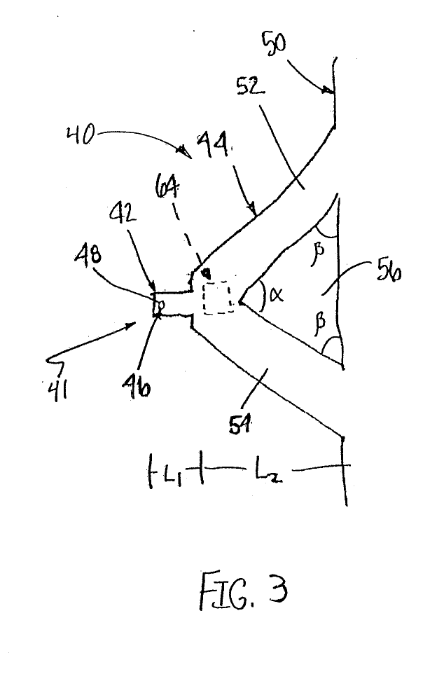

FIG. 3 illustrates an exemplary embodiment of a measurement instrument probe 40 including a cantilever 41 constructed in accordance with the present invention such that it includes at least one lever stage or region 42, which preferably is a probing lever, having a higher effective spring constant and higher effective modulus than another lever stage or region 44, which preferably is an active lever or the like, to help minimize and preferably substantially completely prevent cantilever failure when unexpectedly high attractive or adhesion forces are encountered during operation. Such a multistage cantilever 40 is particularly well suited for oscillatory mode operation in AFMs and the like, including where the probe 40 is operated in TappingMode™ by driving it at a resonant frequency.

In many AFM applications, a relatively stiff cantilever is desired. For example, cantilevers, including cantilevers designed for oscillatory mode use, such as those in particular those used for TappingMode™ operation, have been constructed so as to be relatively stiff throughout its entire lever length such that the cantilever has a relatively high spring constant throughout. For example, cantilevers designed for TappingMode™ operation typically have a spring constant that is constant along its lever length that typically ranges somewhere between 10 N per meter and 100 N per meter. Such a stiff cantilever advantageously enables tapping of the probe tip on or in close proximity to a sample being analyzed to minimize sample damage while enabling it to break the force of adhesion between it and the sample quickly enough to keep it oscillating at or sufficiently near resonance to provide excellent response and resolution.

While a high stiffness cantilever helps to more quickly break the tip free of adhesion and/or attractive forces, when unexpectedly high adhesion and/or attractive forces are encountered, such as due to dust or hydrophilic conditions, its high stiffness limits its ability to bend or “give” a great deal. This can cause the cantilever to become damaged or fail before any force sensing and control arrangement of the measurement instrument is able to react. For example, where the measurement instrument is an AFM that employs an optical lever force sensing feedback arrangement, the rate at which cantilever deflection occurs when encountering such unexpectedly high adhesion and/or attractive forces can be too fast for feedback information to be obtained in time enough for the AFM controller to react and/or for the AFM controller to react fast enough to reduce cantilever force buildup and/or reduce cantilever force.

With continued reference to FIG. 3, a multistage probe 40 constructed in accordance with the present invention has a probing lever stage 42 that is stiffer and of a higher spring constant than at least one other lever stage 44 located between it and where the probe 40 is fixed at its fixed end. This produces a cantilever 40 having a probing lever stage 42 with a stiffness sufficiently high enough to provide the advantages of conventional high stiffness oscillatory mode cantilevers, and at least one other more compliant lever stage 44 that provides more “give” to the probe 40 permitting it to better withstand unexpectedly high adhesive or attractive forces without becoming damaged or failing. In addition, the use of lever stage 44 having a lower effective spring constant provides a region of the probe 40 that is more force sensitive because it deflects or bends more and does so more quickly than conventional stiff cantilevers in response to force(s) at the probing lever stage 42. This increases control response because deflection of a measurable magnitude occurs more quickly and is more pronounced, enabling the force sensing feedback arrangement to more quickly provide meaningful force feedback that the controller can use to adjust cantilever oscillation. In addition, such an arrangement advantageously provides better, more accurate, and more responsive force sensing because small changes in cantilever probing lever force cause the more compliant lever stage 44 to deflect a greater amount and begin deflecting more quickly than the stiffer probing lever stage 42. In sum, compliant lever stage 44 acts as a force sensor that is capable of detecting pN-scale forces.

The probing lever stage 42 preferably includes a sensing element 46 that preferably is a cantilever tip 48 of conventional construction or the like. The probing lever stage 42 preferably has a stiffness of at least 10 N per meter. In one exemplary embodiment, the probing lever stage 42 has a stiffness along its length, L₁, that ranges from about 10 N per meter to as much as about 100 N per meter, with its spring constant preferably being substantially constant along its entire length, L₁.

The more complaint lever stage 44 of the cantilever 41 depicted in FIG. 3 is a single lever stage that adjoins the probing lever stage 42 and extends therefrom to where the cantilever 40 becomes fixed. In the exemplary embodiment depicted in FIG. 3, the fixed end of the more compliant stage 44 is carried by a base 50 such as a substrate of a chip-type base or the like.

Moreover, the more compliant lever stage 44 has a length, L₂, along a direction generally parallel to a longitudinal axis of the probing lever stage 42 that is greater than the length, L₁, of the probing lever stage 42. In one exemplary embodiment, L₂ is at least a plurality of times greater than L₁. More importantly, however, is that the controlling lever L₂ used for feedback control should generally be about 100 times softer than the probing lever L₁. As a result of using a more compliant lever stage 44, cantilever force, namely tip and/or probing lever stage force, transmitted to the more compliant lever stage 44 causes at least a portion of stage 44 to deflect more quickly and by a greater magnitude than the stiffer probing lever stage 42. This enables any measurement instrument force detecting arrangement employed to detect changes in cantilever force(s) to do so more quickly and with greater accuracy/sensitivity. By obtaining force measurement data or information from a more compliant lever stage 44, the detected force changes are conveyed to the measurement instrument control arrangement more quickly than in conventional TappingMode. As a result, the control arrangement can responsively adjust the deflection of the probe and/or how the probe 40 is driven (if such adjustment is determined to be needed) in order to reduce cantilever force buildup and/or reduce force(s).

For example, where an optical lever force detection arrangement is used, the deflection sensing beam is focused onto a portion of the more compliant lever stage 44, such as the target area shown in phantom in FIG. 3 designated by reference numeral 64. If desired, the optical lever beam target 64 can be located on some other part of the more compliant lever stage 44.

In the exemplary embodiment depicted in FIG. 3, the more compliant lever stage 44 has a plurality of lever segments 52 and 54 that converge at the probing lever stage 42 defining an acute angle, α, therebetween as well as preferably defining a generally triangular aperture 56 with the base 50. Each segment 52 and 54 preferably has substantially the same length and forms substantially the same acute angle, β, with the base 50.

While the probe 40 can be driven using one or more conventional drive actuators, such as one or more piezoelectric drive actuators or the like, the probe 40 can also be directly driven, if desired. If desired, one or more drive actuators in operable cooperation with the cantilever itself can be employed instead of or in addition to one or more of the aforementioned conventional drive actuators.

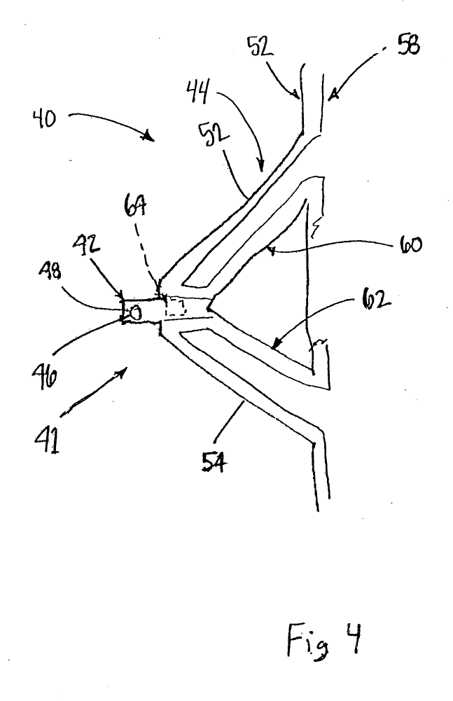

For example, FIG. 4 depicts the probe 40 of FIG. 3 having a drive actuator arrangement 58 in operable cooperation with the cantilever so as to directly affect one or more cantilever parameters and/or characteristics. Such a drive actuator arrangement 58 preferably is a direct contact actuator arrangement that may be integral with some part of the probe 40, preferably at least some portion of a more compliant lever stage.

In the exemplary embodiment depicted in FIG. 4, the drive actuator arrangement 58 includes a pair of drive actuators 60 and 62, each of which is disposed in direct contact with a corresponding more compliant lever stage segment or region 52 and 54. Each drive actuator 60 and 62 is constructed and operated such that a resulting force affects the cantilever 40, such as preferably by causing it to deflect in a manner that affects relative position between the cantilever and the sample.

In one exemplary embodiment, each drive actuator 60 and 62 is a direct contact thermal drive that drives the probe 40 via applied heat creating a thermal stress differential therebetween. Where a thermal drive actuator is employed, each thermal drive actuator preferably is of resistance heating element construction such that electric current of an applied drive signal controls cantilever heating and cooling to regulate the thermal stress differential. Each drive actuator can be driven with a common drive signal or a drive signal applied to one drive actuator that differs in some respect relative to the drive signal applied to the other drive actuator providing independent drive actuator control capabilities.

Depending how driven, the drive actuator arrangement 58 can be driven to deflect the cantilever 40 toward and/or away from a sample being analyzed in the Z-direction, can be driven to cause the tip 48 to displace at an angle relative to a central longitudinal axis of the cantilever 40 in a clockwise or counterclockwise direction (preferably where a plurality of drive actuators, such as 60 and 62, are used and independently driven), and/or can be driven to cause the cantilever 40 to displace or deflect in the ±Y-direction (preferably where a plurality of drive actuators, such as 60 and 62, are used and independently driven).

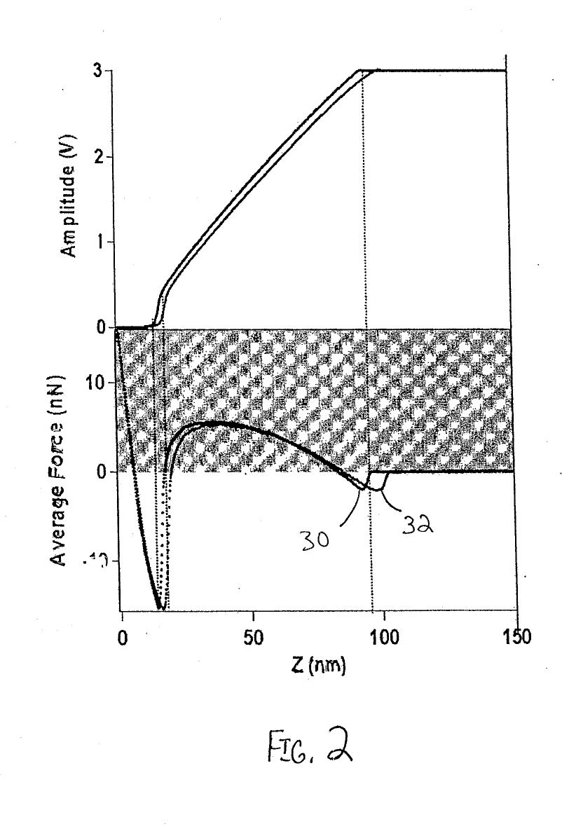

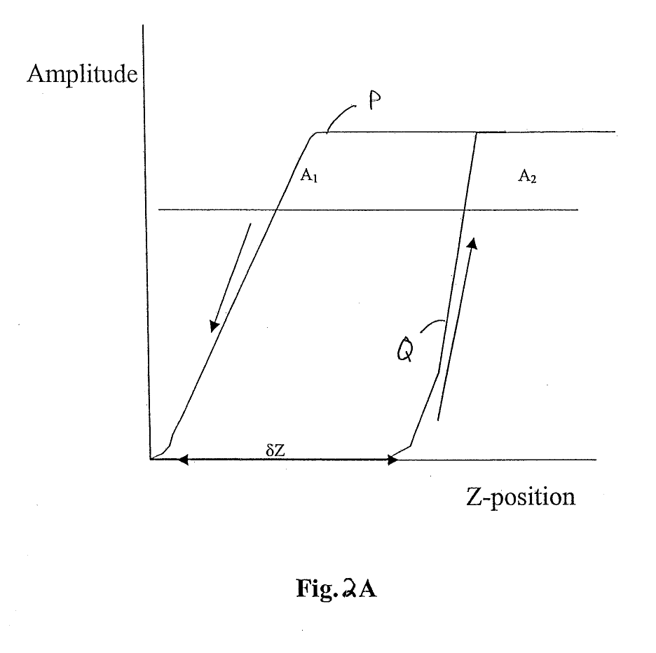

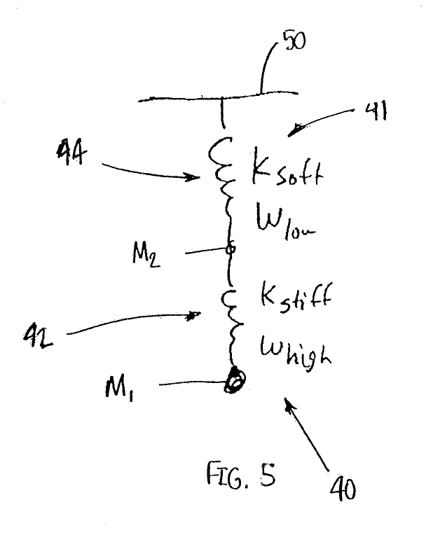

FIG. 5 schematically depicts the probe 40 shown in FIG. 2 as a spring-mass system that includes a mass, M₁, corresponding to that of the probing lever stage 42, k_{stiff}, corresponding to the higher spring constant of the probing lever stage 42, at least one other mass, M₂, corresponding to that of the more compliant lever stage 44, and k_{soft}, corresponding to the lower spring constant of the more compliant lever stage 44. The frequency term, ω_{high}, represents the frequency at which the probing lever stage 42 is oscillating, such as the preferred case where the cantilever 40 is driven in an oscillatory mode, and the frequency term, ω_{low}, represents the frequency of oscillation or displacement of the more compliant lever stage 44.

In a preferred method of operation, the probe 40 is driven so as to oscillate the probing lever stage 42 at a frequency, ω_{high}, such as where it is desired to cause intermittent contact interaction between the sample and probe tip 48. Preferably, the probe 40 is driven to oscillate the probing lever stage 42 at a resonant frequency, such as when it is desired to operate it in TappingMode™. The higher frequency oscillation operation of the probing lever stage 42 gives the probe 40 sufficient energy to avoid sticking to the surface of the sample under normal conditions. In addition, this also prevents dragging the tip 48 across the surface of the sample during scanning.

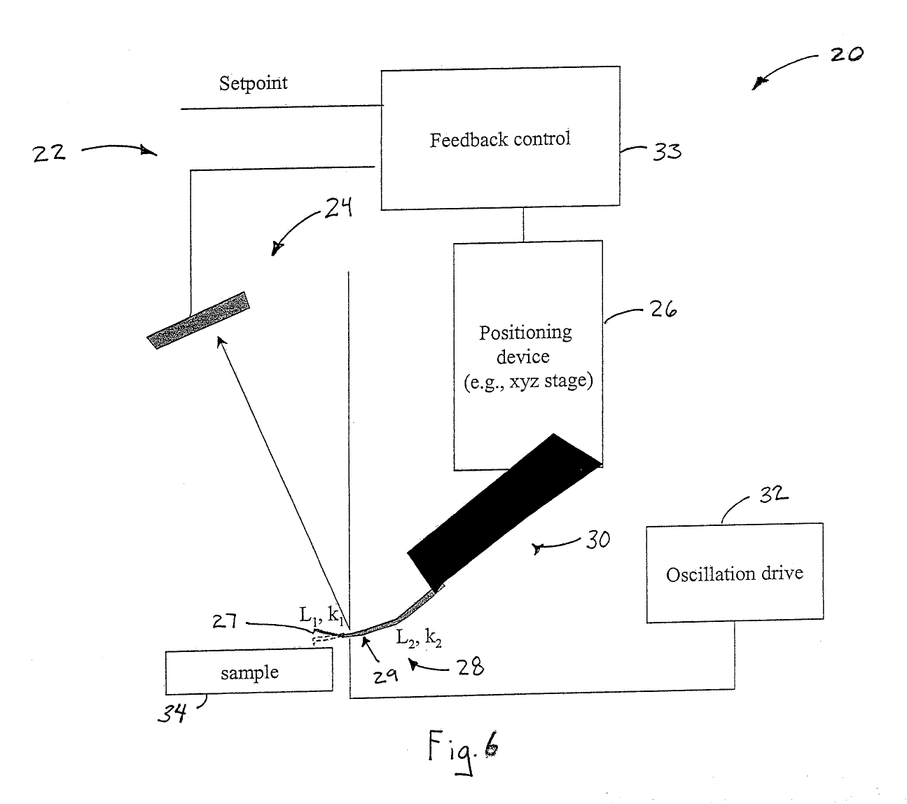

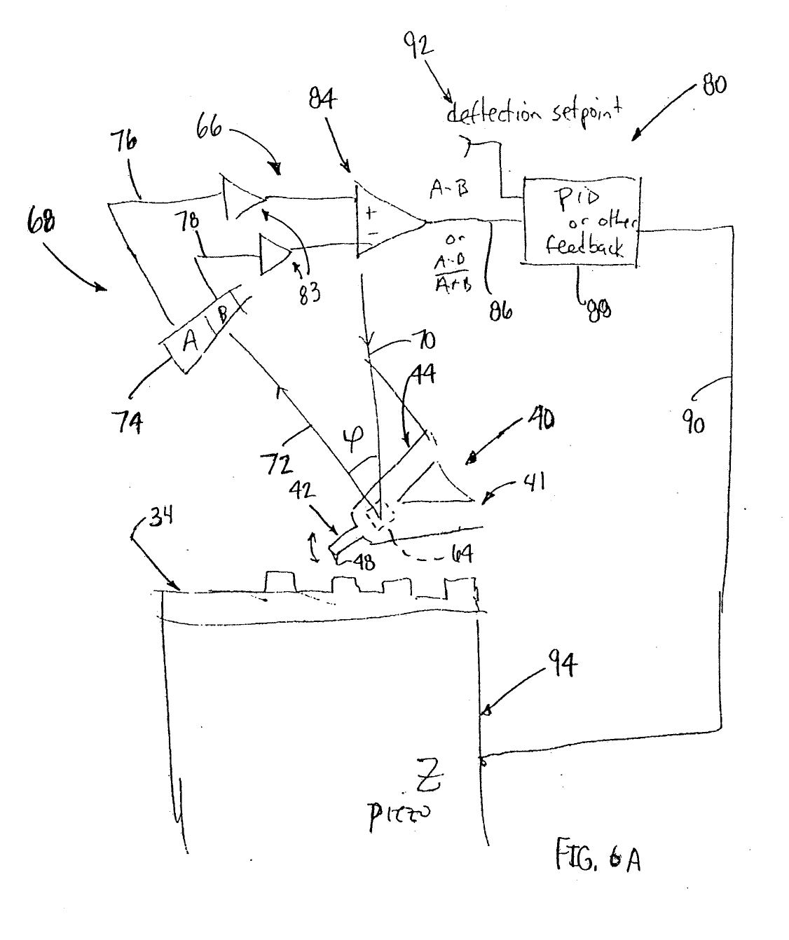

The longer more compliant lever stage 44 provides support for the shorter higher stiffness probing lever stage 42 and its lower stiffness helps dissipate at least some of the force applied to the probing lever stage 42 in the case where tapping or intermittent contact amplitude goes to zero. At least some of the force applied to the stiffer, higher modulus, probing lever stage 42 is transmitted to the softer, more compliant, lower modulus lever stage 44, causing that stage 44 to deflect before the probing lever stage 42 does, advantageously relieving stress buildup in the probing lever segment 42 that would have previously tended to cause probe damage or failure. In general, the force applied to probing lever stage 42 is instantly coupled to lever stage 44 as long as the average force is at a frequency less than fundamental resonance (ω_{low}) of stage 44 (See also Appendices A, B, C and D attached hereto) Turning to FIG. 6, a preferred embodiment of an AFM 20 including a feedback loop 22 and a deflection sensing apparatus 24 that is connected to a positioning device 26 (e.g., an XYZ stage) is shown. Positioning device 26 moves a probe 28 of a probe assembly 30 according to the deflection response of a more compliant lever section (L₂, k₂) of a cantilever 29 as a tip 27 of probe 28 interacts with a sample 34. In operation, a drive mechanism 32 outputs a drive signal that is ultimately applied to a more stiff lever section (L₁, k₁) so that lever L₁ is oscillating at its resonance. Control is via conventional Contact Mode operation, including a feedback control block 33, based on the deflection of L₂, as discussed above. In sum, probing lever section L₁ oscillates while lever section L₂ is used to control feedback, acting essentially as a voltage clamp to prevent tip-sample damage.

FIG. 6A illustrates an exemplary embodiment of an AFM 66 using a multistage multi-modulus probe 40 constructed in accordance with the invention. The AFM 66 includes a detector arrangement 68 from which cantilever positional information and/or force information is obtained during operation. A preferred detector arrangement 68 includes a beam source (not shown), preferably a laser, that outputs an incident beam 70 which preferably impinges against the more compliant lever stage 44, which is wider than the probing lever stage 42. The reflected component 72 of the beam is received by a detector 74 that preferably is a photodetector arrangement that includes a plurality of quadrants and preferably is of four quadrant construction.

Where an optical arrangement like that depicted in FIG. 6 is used to obtain positional and/or force information, the reflected beam angle, φ, is indicative of deflection of the more compliant lever stage 44. This information is obtained from the reflected component 72 being received by the detector 74.

Such information, which can be in the form of one or more signals 76 and 78 outputted by the detector 74, are outputted to a controller 80, such as a digital, analog, or hybrid controller, that is used to determine how to drive the cantilever 40, including in such a manner to control relative position between the cantilever 40 and sample 34 in the X, Y and Z directions. In the preferred embodiment shown in FIG. 5, a pair of analog signals 76 and 78 are conditioned by signal conditioning means 83, for example, an RMS-to-DC converter or a lock-in amplifier, for further processing. More particularly, the conditioned output of means 83 is transmitted to a comparator 84 or the like that communicates its output 86 to a feedback-based control arrangement 88 that preferably employs PI or PID control or the like in the course of generating and outputting an output 90 that is used as or in providing one or more drive actuator drive signals to the various drive actuators of the AFM 66. In the preferred embodiment shown in FIG. 5, a setpoint 92 selected based on, for example, an amplitude or phase of cantilever deflection, and preferably based on a property (e.g., a magnitude of deflection) of the more compliant lever stage 44, is employed as a controller setpoint.

While FIG. 6 depicts a Z-piezo control actuator 94 underlying the sample 34, the Z control actuator can be located elsewhere, including in operable cooperation with the probe 40 in the manner depicted in FIG. 3 and discussed above.

Moreover, if desired, a direct contact drive actuator constructed in accordance with that depicted in FIG. 4 and discussed above can be employed instead of and/or in addition to one or more other piezo-type drive actuators typically employed in an AFM.

When driving the probe 40 such that the probing lever stage 42 is being oscillated at its resonant frequency, tapping force on the probing lever stage 42 is instantly transmitted to the more compliant lever stage 44, causing it to substantially instantly deflect where the transmitted force is great enough. Such instantaneous response by the more compliant lever stage 44 preferably holds true up to its resonant frequency.

The transmitted force preferably causes the more compliant lever stage 44 to deflect or oscillate at a frequency, ω_{low}, that is less than the higher frequency, Φ_{high}, at which the stiffer, less compliant, probing lever stage 42 is being driven. With this knowledge, it is advantageous to obtain feedback, such as in the manner depicted in FIG. 5, from only the more compliant lever stage 44 as it provides greater feedback sensitivity and response.

This cantilever construction, AFM arrangement, and method of use and operation provides several advantages. For example, since deflection measurement preferably is done using the more compliant lever stage 44, its larger surface area exposed toward the beam generator advantageously provides an incident beam target 64 that is much larger than that which could be used of the stiffer probing lever stage 42. This enables use of a laser or other type of beam emitter having a larger beam spot where the incident beam impinges against the more compliant lever stage 44, especially when using a short or otherwise unconventionally small probing lever 42.

A high frequency preamplifier or amplitude modulator is not needed. For example, with the present invention, to achieve a one frame per second imaging speed, a detection arrangement having a bandwidth of no more than about 50 kHz is needed, which is much less than the 1 MHz bandwidth presently available. As a result, there is plenty of bandwidth headroom available to achieve imaging speeds faster than one frame per second and preferably much faster than one frame per second.

Force and/or deflection detection using a more compliant lever stage 44 is instantaneous for all forces transmitted thereto from the probing lever stage 42 in its bandwidth range below its fundamental resonance. As a result, unexpectedly large adhesion and/or attraction forces encountered during imaging are detected instantly as they are encountered, providing the controller greater time in which to react and adjust how the probe 40 is driven to help reduce the rate of cantilever force buildup and/or force to an acceptable level that minimizes cantilever damage and failure. This enables feedback based on, e.g., the deflection of the more compliant lever stage 44. The deflection response time is similar to that when operating in conventional Contact Mode, and as such the preferred embodiments are much faster than conventional TappingMode, in which the corresponding time constant is defined by Equation 2.

Another advantage of the present invention is that it is capable of providing the ability to base feedback on average tapping force just by position and/or force detection using the more compliant lever stage 44. While AFMs using conventional oscillatory mode cantilevers often base feedback on amplitude, the higher cantilever stiffness does not provide a straightforward dependence on amplitude. The tapping force is not monotonic with amplitude as it typically depends upon sample material properties, etc.

In contrast, the use of a more compliant lever stage 44 that is longer than the probing lever stage 42 provides a more consistent measure of tapping force that is independent of the material of which the sample is composed, oscillation frequency, drive phase, and other factors that can impact the data determined based on changes in one or more probe properties. The more compliant lever stage 44 advantageously directly and dumbly responds to whatever actual tapping force is generated and experienced by the probing lever stage 42. Moreover, the lever stage 44 operates to absorb unexpected high forces such as may be caused by feedback loop failure in standard TappingMode operation, thus minimizing damage to the tip and/or sample as a result of not, or not quickly enough, adjusting probe oscillation back to the setpoint.

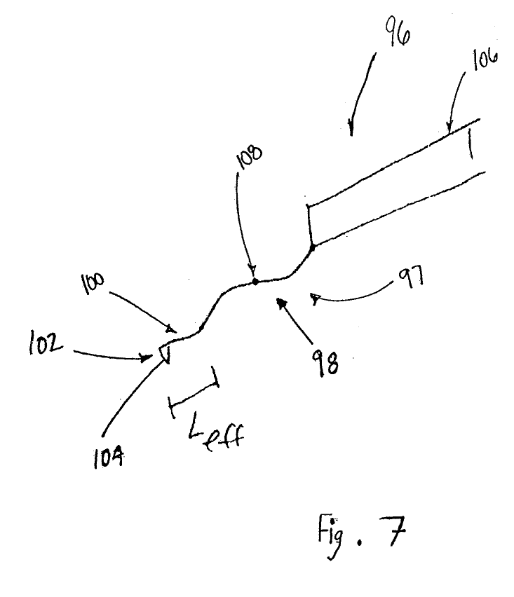

FIG. 7 illustrates a preferred embodiment and method of implementing a multistage probe 96 having a cantilever 97 in accordance with the present invention that is capable of being driven or excited in a manner that causes one section 98 of cantilever 97 to operate with a lower effective spring rate/constant and lower effective modulus than a probing lever section 100 of the probe 96 using a conventional probe (e.g., using a compliant probe, for example, as used in contact mode, having an actual spring constant (k) of about 0.1 to 0.6 N/m). When driven or excited in such a manner, the probing lever section 100 has a higher effective spring constant, a higher effective modulus, and preferably has a shorter effective length, L_{eff}, than the effectively more compliant cantilever section 98. As is shown in FIG. 7, the probing lever section 100 preferably is located at or adjacent the free end of the cantilever 97. The probing lever section 100 preferably also includes a sensing element 102, preferably a probe tip 104 or the like.

As is shown in FIG. 7, the more compliant lever section 98 during operation extends outwardly from a base 106, such as a substrate of a probe chip or the like. The probe 96 is driven or excited such as in a manner and/or using one or more drive actuators and types of drive actuators as discussed above and/or shown in FIGS. 4 and/or 6. In one preferred embodiment, a direct-contact mechanical drive arrangement, preferably a thermal drive arrangement using at least one thermal drive actuator, such as of the type depicted in FIG. 4, can be used to drive the probe 96 preferably by directly driving the lever section 98.

The probe 96 is driven or excited to cause the it to oscillate it at a higher mode of its resonance, which imparts a higher effective spring constant, resonant frequency and Q to the probing lever section 100 than lever section 98. This desirably helps prevent tip 104 from sticking under both normal conditions and conditions during which unexpectedly high adhesion and/or attractive forces are encountered. In addition, the resultant higher Q provides a desirably low tapping force, which helps prevent sample damage and improves imaging resolution.

As with cantilever 41, the feedback beam target 108 is located somewhere along the more compliant lever section 98. Preferably, the feedback beam target 108 is located at or near a locus of minimal oscillation amplitude, e.g., a node, such as is depicted in FIG. 7, so that cantilever deflection can be accurately detected by the detection arrangement. This is due to the fact that at the higher order node the probe is substantially insensitive to bending of the node. Depending on the oscillation frequency and harmonics, the location of the target 108 can be adjusted as needed to position it at or sufficient close to a node to ensure accurate deflection detection and measurement. Alternatively, higher order modes, which are about 6-30 times the fundamental mode, can be time frequency filtered with a low pass filter to obtain the desired data.

One advantage of the present embodiment and implementation of the invention is that a lower stiffness contact mode cantilever of conventional construction can be used. In this regard, a conventional cantilever having a constant width and/or thickness and made of the same material along its entire length can be used and driven or excited in a manner that produces cantilever 96. Another advantage is that higher order mode(s) can be excited mechanically and via direct cantilever drive actuators without requiring the need to use more complex drive schemes such as thermal excitation. That said, a thermal drive actuator of the type depicted in FIG. 4 can be used to drive probe 96 in the desired manner to produce the desired harmonics to operate the probe 96 in an aforementioned multistage cantilever operational mode.

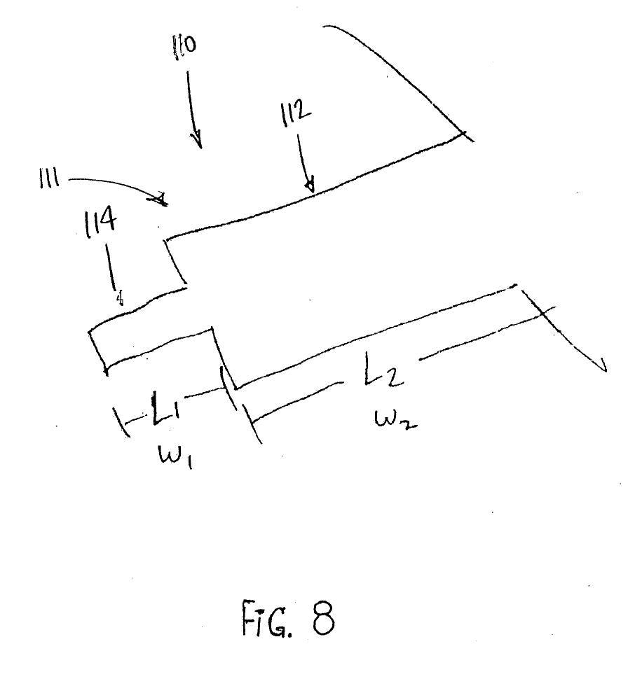

FIG. 8 illustrates a still further preferred embodiment of a multistage probe 110 having a cantilever 111 constructed in accordance with the invention that is operated in a manner the same as or like that of probe 96 shown in FIG. 6, but is configured such that the lever section 112 driven to have a lower effective spring rate, lower resonant frequency and lower Q is both wider and longer than the probing lever section 114 driven to have a higher effective spring rate, higher resonant frequency and higher Q. Preferably the length, L₁, of the probing lever section 114 and the frequency, ω₁, at which the probing lever section 114 oscillates during operation is a higher order resonance of the frequency, ω₂, of the more compliant lever section 112 having length, L₂. As a result, the cantilever 110 can be driven in a manner that produces very high resonant frequencies, ω₁, preferably above 10 khz, in the probing lever section 114 with this type of frequency matching.

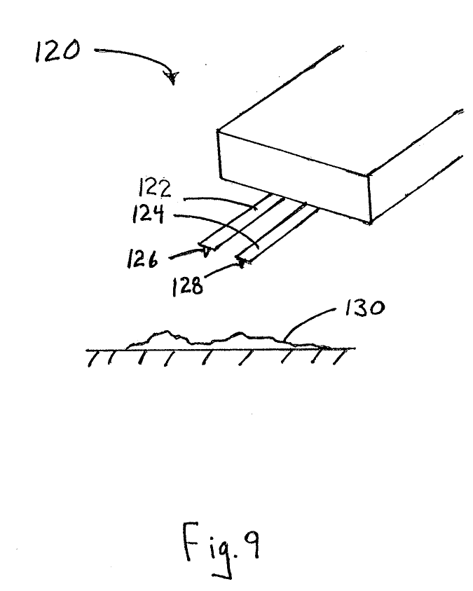

Turning to FIG. 9, an alternative multi-stage probe 120 with features similar to the above-described preferred embodiments is shown. In contrast to the serial construction of the previous embodiments however, probe 120 has cantilever stages having a substantially parallel construction. In particular, probe 120 includes two independent lever stages 122, 124 spaced closely from one another and having a respective stylus or tip 126, 128 designed to interact with a sample 130. Stage 122 has a first spring constant, k₁, which is softer than a spring constant, k₂, of adjacent stage 124. In operation, the two stages 122 and 124 can be maneuvered independently or conjunctively.

Although the best mode contemplated by the inventors for carrying out the present invention is disclosed above, practice of the present invention is not limited thereto. It will be manifest that various additions, modifications and rearrangements of the features of the present invention may be made without deviating from the spirit and scope of the underlying inventive concept. The scope of still other changes to the described embodiments that fall within the present invention but that are not specifically discussed above will become apparent from the appended claims.

1. A measurement instrument probe having at least one outwardly extending sensing lever having one stage that, at least during operation, has a spring constant that is different than a spring constant of another stage adjacent to the one stage.

2. The measurement instrument probe of claim 1, wherein the one stage is a probing lever stage and is disposed at or adjacent a free end of the sensing lever and the sensing lever is driven or excited in a manner that causes the probing lever stage to have an effective spring constant, k₁, that is greater than an effective spring constant, k₂, of the adjacent stage which is disposed between the probing lever stage and where the sensing lever is fixed.

3. The measurement instrument probe of claim 2, wherein the probing lever stage and the adjacent lever stage have substantially the same spring constant when the sensing lever is not being driven in a manner that causes their effective spring constants to differ.

4. The measurement instrument probe of claim 3, wherein the probing lever stage and the at least one other lever stage are comprised of the same material.

5. The measurement instrument probe of claim 3, wherein the probing lever stage and the at least one other lever stage comprise a cantilever of one-piece, unitary and homogeneous construction.

6. The measurement instrument probe of claim 2, wherein the effectively less stiff one other lever stage has a longitudinal length, L₂, that is at least a plurality of times longer than a longitudinal length, L₁, of the effectively stiffer probing lever stage.

7. The measurement instrument probe of claim 6, wherein the effectively less stiff one other lever stage is driven or excited into a harmonic oscillatory mode and an incident beam of a force and/or deflection detection arrangement impinges on the effectively less stiff one other lever stage at or near a locus of minimal amplitude thereof.

8. The measurement instrument probe of claim 7, wherein the incident beam of the force and/or deflection detection arrangement is directed onto the effectively less stiff one other lever stage so it impinges at a node thereof.

9. The measurement instrument probe of claim 2, wherein the sensing lever is driven or excited such that the probing lever stage oscillates in an oscillatory mode.

10. The measurement instrument probe of claim 6, wherein the effectively less stiff one other lever stage has a width, W₂, that is wider than a width, W₁, of the effectively stiffer probing lever stage.

11. The measurement instrument probe of claim 1, wherein the sensing lever comprises a cantilever that is fixed at or adjacent one end of the cantilever and which includes a probing lever stage that is stiffer, at least during operation, than at least one other lever stage.

12. The measurement instrument probe of claim 11, wherein the probing lever stage is disposed at or adjacent a free end of the cantilever, and has a spring constant, k₁, greater than a spring constant, k₂, of a less stiff lever stage that is disposed between the probing lever stage and where the cantilever is fixed.

13. The measurement instrument probe of claim 1, wherein the at least one sensing lever includes at least two sensing levers with substantially different spring constants and which are constructed in parallel on a fixed base.

14. The measurement instrument probe of claim 13, wherein the substantially different spring constants are at least 10% different.

15. The measurement instrument probe of claim 14, wherein the probing lever stage is constructed and arranged to provide information from interacting with a sample with which it is disposed in close proximity thereto.

16. The measurement instrument probe of claim 15, wherein the probing lever stage comprises a sensing element, and wherein the sensing element comprises a tip, and wherein the tip has a radius of between about 2 nm and about 200 nm.

17. A cantilever for an AFM probe having a probing lever stage carrying a sensing element at or adjacent a free end of the cantilever that is less compliant than another lever stage disposed interjacent the probing lever stage and where the cantilever is fixed.

18. A method of operating a surface analysis instrument having a probe including a cantilever having a plurality of regions, the method comprising:
using at least a first one of the regions to interact with a sample, the interaction being coupled to at least a second one of the regions of the probe;
sensing a response of the second one of the regions; and
controlling a positioning stage in response to said sensing step.

19. The method of claim 18, wherein the response is a deflection of the at least a first one of the regions.

20. The method of claim 18, wherein the regions of the probe include an outwardly extending sensing lever section that, at least during operation, has a spring constant that is different than a spring constant of another section adjacent to the one section.
